(19) United States
(12) Patent Application Publication
(10) Pub. No.: US 2004/0172914 A1
(43) Pub. Date: Sep. 9, 2004

(54) Seamless door and methods of manufacture

(76) Inventor: Sergio Lancia, Concord (CA)

Correspondence Address: Richard J. Streit, Ladas & Parry, 224 South Michigan Avenue, Suite 1200, Chicago, IL, 60604, US

(21) Appl. No.: 10/393,331

(22) Filed: Mar. 20, 2003

(30) Foreign Application Priority Data
Mar. 3, 2003 (CA) 2,420,761

(51) Int. Cl. B32B 31/00

(52) U.S. Cl. 52/784.1; 156/154

(57) ABSTRACT

A seamless door and a method manufacturing a seamless door are provided. The door is comprised of: a core composed of processed wood product being a grade suitable for routering without chip-out, vertical members, veneer which covers the front and back of the door and edging which covers the peripheral edges of the door. The door has no visible seams or joints and can be constructed to mimic a rail and stile door by carving profiles into the door.

### CROSS-REFERENCED TO RELATED APPLICATIONS

This application claims priority from Canadian application no. [not yet known], filed Mar. 3, 2003.

### FIELD OF THE INVENTION

This invention relates doors and methods of their manufacture.

### BACKGROUND OF THE INVENTION

Rail and stile doors are widely used in the building and cabinet industries. Generally a rail and stile door is comprised of three components: rails, stiles and a centre panel. The rails form the horizontal portions of the doors and the stiles form the vertical portions of the doors. Additional horizontal and vertical rails are required for doors with multiple panels.

During manufacture, the rails and stiles may be processed by a machine, such as a soft former, which manufactures grooves on the inside edges of the stiles and rails while a double-end tennoner machines a cope on the ends of the rails. The copes on the rails fit into the patterns comprising the groves on the stiles for connecting the two components together. Glue may then be applied to the intersecting portions of the stiles and rails, and the pieces assembled together as a frame around center panel. The center panel, as well as the stiles and rails, are traditionally held in place with staples to provide strength while the glue cures.

Traditional rail and stile doors have suffered several disadvantages. First, traditional rail and stile doors, while strong, are susceptible to cracks at joints when subjected to climatic changes. Second, the manufacturing process is labour intensive and expense. Although machines may be used to perform some of the processes used in forming a raised panel door, many processes are performed by hand. Third, traditional rail and stile doors are also costly to manufacture since they are typically constructed with solid wood. It is increasingly becoming more difficult to find wood without blemishes such as knots and with consistent colour and graining.

One cheaper alternative material for door construction which has become of increasing interest is medium density fiberboard (“MDF”), a man-made processed wood product. For many years, MDF has been used as a construction material for smaller, lightweight items such as cabinet doors. However, MDF alone has not been used in the construction of either interior or exterior doors since a single door-size piece of MDF lacks the necessary rigidity and strength of solid wood.

Methods exist which combine MDF with other materials in an attempt to make a suitable replacement for a solid wood rail and stile door. Typically these methods employ a particle board core, softwood edge banding and a hardboard face veneer. In construction, the particle board core is cut to form a frame to receive MDF panels and moulding. Alternatively, a desired raised panel profile can be cut directly into the particle board core and the design topped with MDF. However, as with traditional wood rail and stile doors, these doors also suffer numerous disadvantages. MDF/particle board doors can suffer structural problems since MDF and particle board have different structural qualities and can react to climatic changes in different ways, thus causing cracks to appear at the seams between the materials. The construction of MDF/particle board doors can also be labour intensive, involving a large number of assembly steps. For example, particle board tends to flake when cut therefore requiring the additional step of capping cut surfaces.

Thus an improved door and method of manufacturing doors is needed for the manufacturing of doors which are inexpensive, easy to assemble and have improved structural properties over prior art wood doors.

Accordingly, it is an object of the present invention to provide an improved door and a method of manufacturing the same, which is cost effective and has the minimum number of assembly steps.

It is another object of the present invention to provide an improved door and a method of manufacturing the same, which requires the minimum amount of solid wood components.

It is another object of the present invention to provide an improved door and a method of manufacturing the same, which has no joint seams and as such is not susceptible to damage due to climatic changes.

It is another object of the present invention to provide an improved door and a method of manufacturing the same, which can be adapted to have the appearance of a traditional rail and stile door.

### SUMMARY OF THE INVENTION

In accordance with one aspect of the invention, there is provided a door comprising: a core composed of processed wood product having a front surface, a back surface, a top surface, a bottom surface, and side surfaces, wherein the processed wood product is a grade suitable for routering without chip out.

In an embodiment of the invention, the door further comprises: a plurality of vertical members having a top surface, a bottom surface; and side surfaces and being at least the same height and thickness as the core; and wherein a side surface of one vertical member is attached to a side surface of the core; a plurality of horizontal members having a top surface, a bottom surface; and side surfaces and being at least the same width and thickness as the core; and wherein one horizontal member is attached to the top surface of the core and one horizontal member is attached to the bottom surface of the core.

In a further embodiment of the invention, the door further comprises: a first sheet of veneer and a second sheet of veneer being at least the same height as the core and being at least the same width as the combined width of the core and the vertical members and wherein the first sheet of veneer is fixed to the front surface of the core and the front surface of the vertical members and the front surface of the horizontal members and wherein the second sheet of veneer is fixed to the back surface of the core and back surfaces of the vertical members and the back surface of the horizontal members.

The invention also provides a method of manufacturing a door comprising: providing a core composed of processed wood product said core having a front surface, a back surface and side surfaces wherein said processed wood product is a grade suitable for routering without chip out; providing an engraving tool; and using the engraving tool to engrave a predetermined design into a surface of the door.

In an embodiment of the invention, the method of manufacturing a door, prior to using the engraving tool, further comprises the steps of: providing a plurality of vertical members having a front surface, a back surface and side surfaces; attaching a side surface of one vertical member to a side surface of the core; providing a plurality of horizontal members having a front surface, a back surface and side surfaces; attaching the bottom surface of one horizontal member to the top surface of the core; attaching the top surface of one horizontal surface to the bottom surface of the core; providing a first sheet of veneer; gluing said first sheet of veneer the front surface of the core and the front surface of the vertical members and the front surface of the horizontal members; providing a second sheet of veneer; gluing the second sheet of veneer to the back surface of the core and the back surface of the vertical members and the back surface of the horizontal members to form a door assembly having a front surface, a back surface, a top surface, a bottom surface, and side surfaces; providing edging; gluing said edging to the top surface, the bottom surface and the side surfaces of the door assembly; providing a hydraulic press; applying pressure to the door assembly using the hydraulic press; providing an engraving tool; and using the engraving tool to engrave a predetermined design into a surface of the door.

In an embodiment of the invention provides a method of manufacturing a door further comprising engraving a desired design in the back surface of the door.

### BRIEF DESCRIPTION OF DRAWINGS

Preferred embodiments of the invention will now be described, by way of example, with reference to the accompanying drawings, in which:

FIG. 1 is a front perspective view of the door assembly, partly cut away;

FIG. 2 is front perspective view of the core and stiles;

FIG. 3 is a bottom, cross sectional view of the door assembly, partly cut away;

FIG. 4 is a bottom, cross sectional view of the door assembly, with the edging on the bottom surface partly cut away; and

FIG. 5 is a front view of the door assembly, with the front surface engraved.

FIG. 5A is a side, cross sectional view of the door assembly, with the front surface engraved.

### DETAILED DESCRIPTION

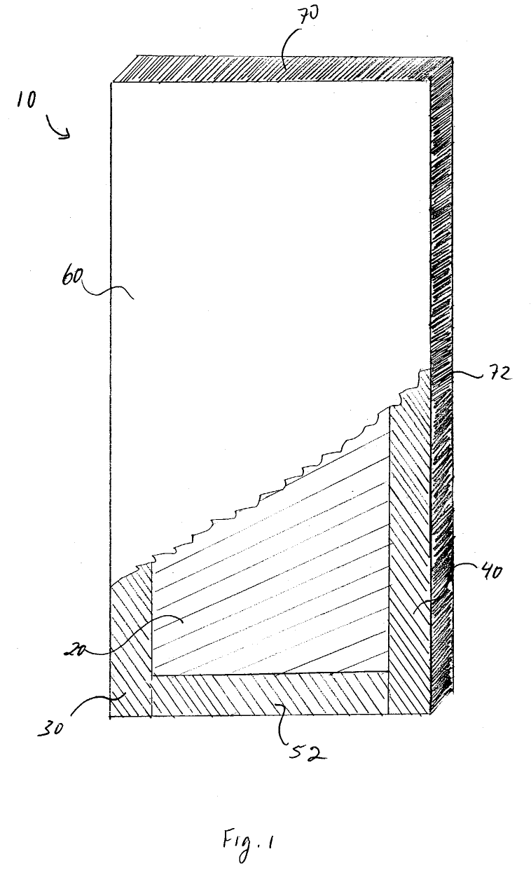

The invention is a seamless door and a method of manufacturing the same. Referring to FIGS. 1,2, and 3 the invention provides a seamless door 10 comprising: a core 20 composed of a processed wood product, vertical members 30 and 40, horizontal members 50 and 52, a first sheet of veneer 60, a second sheet of veneer 62 and edging 70, 72, 74 and 76. The components comprising the seamless door 10 are described in greater detail below.

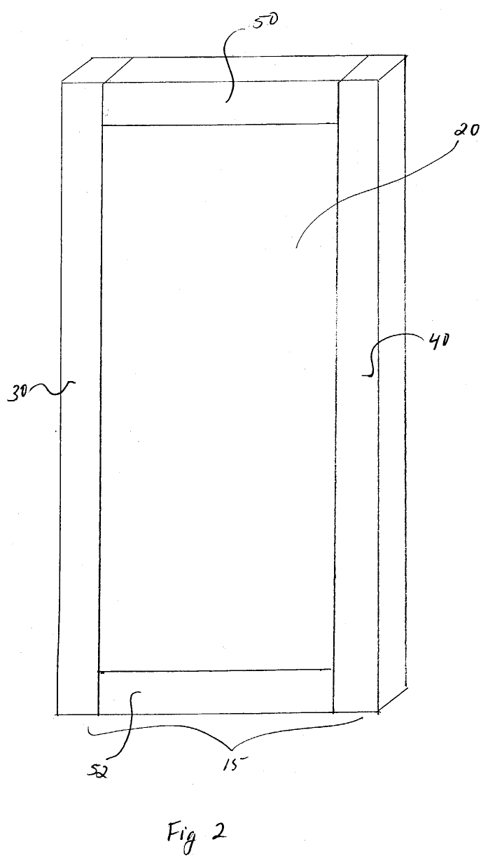

The invention also provides a method for manufacturing a seamless door 10. The first step of the invention is the provision of a core 20 as shown in FIG. 2, composed of a suitable processed wood product such as medium density fibre board (MDF). In a preferred embodiment, the core 20 is composed of Ranger Board™ (available from West Timber Fraser Co, Ltd.) or another superior MDF. It will be appreciated that other superior quality brands of MDF can also be used.

Two important characteristics of processed wood products such as MDF are density and internal bond. Together these two characteristic describe a product's structural strength. Density in the context of processed wood products is the amount of wood substance enclosed within the boundaries of the wood-plus-voids complex. Density is generally expressed in pounds per cubic foot (pcf). A heavier product will generally be stronger than a lighter product. Internal bond is a measure of a material's integrity illustrating how durable the material is bonded together. Internal bond is generally expressed in pounds per square inch (psi) and represents the force perpendicular to the panel surfaces required to pull a standard test sample apart.

Typically standard MDF (i.e. MDF constructed in accordance with the minimum standards set by the American National Standards Institutes), will have a density between 31 and 55 pcf (496-880 kg/m³) with the average density generally being 40 pounds pcf (640 kg/m³) and the average internal bond of 80 psi (552 kPa). In comparison, Ranger Board™ MDF is significantly stronger. In terms of density, Ranger Board™ type MDF is substantially denser having a density ranging between 47 and 52 pcf (752-832 kg/m³) depending on the thickness of the board. Ranger Board™ can withstand greater applications of force compared with other types of MDF having an internal bond ranging between 110-130 psi (759-897 kPa). Ranger Board™ is also superior in terms of its ability to hold screws. Standard MDF typicially have a screw holding face value of 300 pounds (136 kg) and a screw holding edge value of 225 pounds (102 kg) whereas Ranger Board™ has a screw holding face value of 315 to 325 pounds (142-147 kg) and a screwing holding edge value of 300 pounds (136 kg).

The core 20 can be cut from sheets of Ranger Board™ MDF or any other suitable MDF using any suitable type of saw as known in the prior art. Preferably the core 20 will have a density between 40 and 70 pcf (640-1121 kg/m³), more preferably between 50 and 55 pcf (800-880 kg/m³). Preferably the core 20 will have an internal bond of between 90 and 150 psi (621-1035 kPa) and more preferably between 100-130 psi (690-897 kPa), or more preferably between 110 and 120 psi (759-828 kPa). A core with these qualities can be routered without chip out, thus no filling or sanding is required after routering.

The dimensions of the core 20 will depend on the desired dimensions of the completed door 10. Typically the core 20 will be between 80″ and 96″ (200-240 cm) high, 18″ and 36″ (45-90 cm) wide and have a thickness of 1⅜″ to 2¼″ (3.45-5.6 cm).

Numerous advantages are incurred with the use of properly selected MDF such as Ranger Board™. In comparison with solid wood, MDF is more readily available and as such is less costly. In comparison with particle board or chipboard, properly selected MDF can be cut or routered into intricate designs without chipping or flaking. MDF is omni-directional, so that if the right qualities and standards are selected, it can be shaped and finished without grain and pitting problems associated with solid lumber or particle board. It provides a more stable core, less affected by climate. It has a superior surface for painting and laminating. There is no end porous structure. The random fiber orientation eliminates warping while increasing the strength and impact resistance.

The next step in the manufacture of the seamless door is the provision of vertical members 30 and 40 and horizontal members 50 and 52 as shown in FIG. 2. The height and thickness of the vertical members 30 and 40 are at least same as the height and thickness of the core 20. Typically the vertical members 30 and 40 will be 1¼″ to 2″ (3.1-5.0 cm) wide. The width and thickness of the horizontal members are at least the same as the width and thickness of the core 20. Any overhangs can be trimmed at a later point.

The verticals members 30 and 40 and horizontal members 50 and 52 are composed of a suitable material, preferably solid wood such as finger jointed pine. The vertical members 30 and 40 and horizontal members 50 and 52 bolster the structural integrity of the MDF core 20. The vertical members 30 and 40 and horizontal members 50 and 52 provide strength and rigidity to the completed door 10 with the minimum amount of solid wood. The vertical members 30 and 40 also provide a suitable medium for the ease of attachment of hardware such as hinges, door knobs and locks.

Next, the vertical members 30 and 40 and the horizontal members 50 and 52 are respectively aligned with the vertical and horizontal surfaces the core 20 such that the outer edges of the vertical members 30 and 40, the horizontal members 50 and 52 and the core 20 are substantially flush as shown in FIG. 2. The vertical members 30 and 40, the horizontal members 50 and 52 and the core 20 are then bonded together with any suitable adhesive as known in the prior art to form the door interior 15. It is unnecessary to use joints or fasteners to attach the either the vertical members 30 and 40 or the horizontal members 50 and 52 to the core 20.

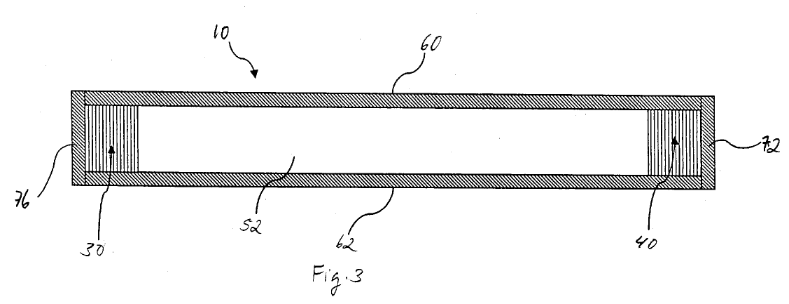

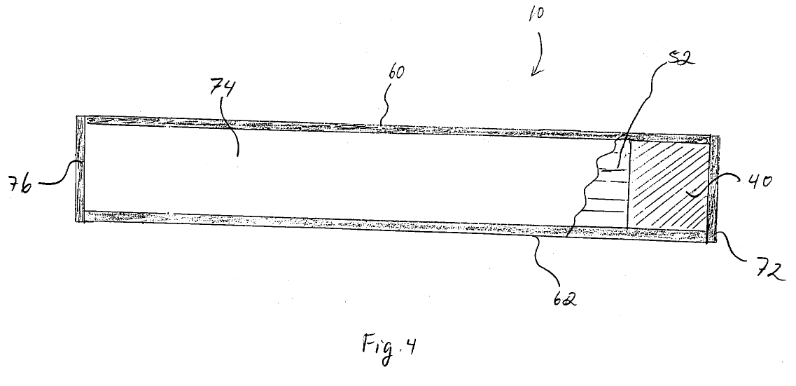

Now referring to FIGS. 3 and 4, the next step is the provision of a first sheet of veneer 60. The first sheet of veneer 60 will have a height and width at least equal to the height and width of the door interior 15. The thickness of the first sheet of veneer 50 will typically be ⅛^{th} ″ (3 mm).

The first sheet of veneer 60 is composed of either wood or synthetic materials. Preferably, a wood veneer such as hard board can be used. It will be appreciated that other types of veneer can be used such as masonite.

The first sheet of veneer 60 is aligned with the door interior 15 and glued to the front surface of the door interior 15 using any suitable adhesive as known in the prior art.

The next step is the provision of a second sheet of veneer 62. The dimensions and composition of the second sheet of veneer 62 are substantially the same as for the first sheet of veneer 60.

Next, the second sheet of veneer 62 is aligned with the door interior 15 and glued in the same fashion as for the first sheet of veneer 60, to the back surface of the door interior 15 to form a laminated door assembly.

Since the veneer 60 and 62 covers the door interior 15, it is unnecessary to match the colour and grain patterns of the materials comprising the core 20, the vertical members 30 and 40, and the horizontal members 50 and 52. The veneer 60 and 62 also provides an easily finished surface accepting both paint and stain.

Referring to FIGS. 1 and 4, the next step in the manufacture of the seamless door is the provision of edging 70, 72, 74, 76. Typically the edging 70, 72, 74, 76 will be 1¼″ (3.1 cm) wide and have a thickness between 1¼ and a 1½ inch (3.1-3.8 cm). The edging is mounted to the peripheral surfaces of the door interior 15 and glued to all 4 sides in distinct pieces. Alternatively, where the appearance of a wooden door is not necessary, the use of edging can be restricted to the top and bottom surfaces of the door interior 15.

The edging 70, 72, 74, 76 is composed of a suitable material, preferably solid wood such as pine. The edge banding 70, 72, 74, and 76 can be connected together via finger joints such that the peripheral surfaces of the completed door 10 are seamless.

The use of edging increases the strength and integrity of the completed door 10. The use of edging composed of wood also allows for ease of finishing the door 10 with either paint or stain and ease of attaching door hardware such as hinges.

The next step is to place the door 10 in a hydraulic press. Pressure is applied to the door using a hydraulic press and typically the door 10 will be allowed to cure for 90 minutes.

Once the door is cured, any rough edges can be removed and squared with a double end tennoner. The door 10 is now complete. The completed door 10 has no joints and no visible seams. As such, the completed door 10 is structurally superior to traditional rail and stile doors since there are no joints which can crack in response to changes in atmospheric conditions. The lack of seams also results in a completed door 10 which is aesthetically pleasing.

The invention also provides a method of manufacturing a seamless door which can mimic the raised panel appearance of traditional rail and stile doors. Once the door 10 is cured and any rough edges removed, a computer numeric router (CNC router) is provided and the door 10 positioned in the CNC router.

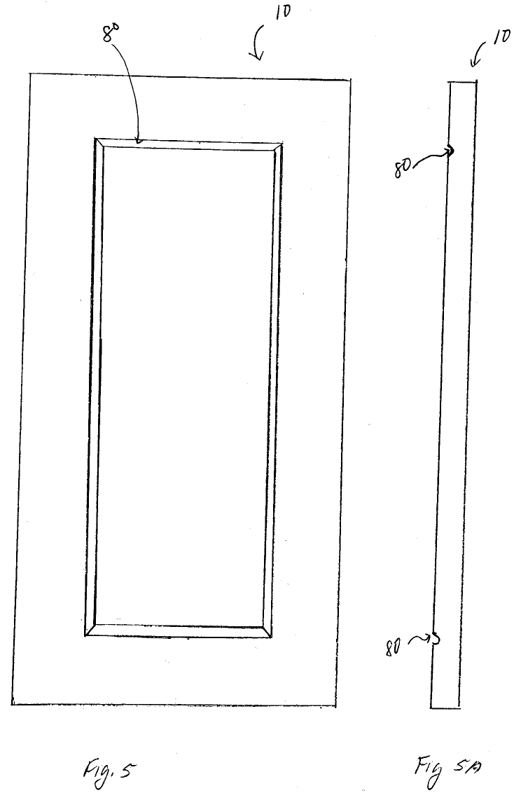

Next, a predetermined profile 80 as shown in FIGS. 5 and 5A, can be carved into either the front surface of the door 10, the back surface of the door 10 or the both surfaces of the door 10. It will be appreciated by the person skilled in the art that the CNC router can be programmed to carve a multitude of different profiles into the door 10.

Once the desired profile is carved into the door 10, the door 10 can be finished with paint or stain. The use of MDF eliminates the need to cap any cut surfaces, saving money and increasing efficiency. Thus the finished product has no seams between the structural pieces. This eliminates the possibility of cracks forming in changing environmental conditions.

Although the invention has been described with reference to illustrative embodiments, it is to be understood that the invention is not limited to these precise embodiments, and that various changes and modifications may be affected therein by one skilled in the art. All such changes and modifications are intended to be encompassed by the appended claims.

What is claimed is:

1. A door comprising:
a core composed of processed wood product having a front surface, a back surface, a top surface, a bottom surface, and side surfaces, wherein said processed wood product is a grade suitable for routering without chip out.

2. A door according to claim 1 further comprising:
a plurality of vertical members;
said vertical members having a top surface, a bottom surface; and side surfaces;
said vertical members being at least the same height and thickness as the core;
wherein a side surface of one vertical member is attached to a side surface of the core;
a plurality of horizontal members;
said horizontal members having a top surface, a bottom surface; and side surfaces;
said horizontal members being at least the same width and thickness as the core;
wherein one horizontal member is attached to the top surface of the core and wherein one horizontal member is attached to the bottom surface of the core.

3. A door according to claim 2 wherein the vertical members and the horizontal members are composed of wood.

4. A door according to claims 2 further comprising:
a first sheet of veneer and a second sheet of veneer,
said first and second sheet of veneer being at least the same height as the core;
said first and second sheet of veneer being at least the same width as the combined width of the core and the vertical members;
wherein the first sheet of veneer is fixed to the front surface of the core and the front surfaces of the vertical members and the front surfaces of the horizontal members and wherein the second sheet of veneer is fixed to the back surface of the core and back surface of the vertical members and the back surface of the horizontal members;

5. A door according to claim 4 wherein the veneer is wood veneer or masonite.

6. A door according to claim 4 further comprising:
an edging wherein the edging covers the top and bottom surfaces of the core, the top, bottom and side surfaces of the vertical members.

7. A door according to claim 6 wherein the edge banding is comprised of wood.

8. A door according to claim 1 wherein the core is comprised of medium density fiberboard.

9. A door according to claim 8 wherein the medium density fiberboard has a density greater than 40 pounds per cubic foot (640 kg/cubic meter).

10. A door according to claim 8 wherein the medium density fiberboard has an internal bond greater than 110 pounds per square inch (759 kPa).

11. A door according to claim 8 wherein the medium density fiberboard has internal bond of at least 110 pounds per square inch (759 kPa).

12. A door according to claim 8 wherein the medium density fiberboard is Ranger Board.

13. A method of making a door comprising:
providing a core composed of processed wood product said core having a front surface, a back surface and side surfaces wherein said processed wood product is a grade suitable for routering without chip out;
providing an engraving tool; and
using the engraving tool to engrave a predetermined design into a surface of the door.

14. A method of making a door according to claim 13 further comprising, prior to using the engraving tool, the steps of:
providing a plurality of vertical members having a front surface, a back surface and side surfaces;
attaching a side surface of one vertical member to a side surface of the core;
providing a plurality of horizontal members having a front surface, a back surface and side surfaces;
attaching a bottom surface of one horizontal member to the top surface of the core;
attaching a top surface of one horizontal member to the bottom surface of the core;
providing a first sheet of veneer;
gluing said first sheet of veneer the front surface of the core and the front surface of the vertical members and the front surface of the horizontal members;
providing a second sheet of veneer;
gluing the second sheet of veneer to the back surface of the core and the back surface of the vertical members and the back surface of the horizontal members to form a door assembly having a front surface, a back surface, a top surface, a bottom surface, and side surfaces;
providing edging;
gluing said edging to the top surface, the bottom surface and the side surfaces of the door assembly;
providing a hydraulic press; and
applying pressure to the door assembly using the hydraulic press.

15. A method according to claim 13 further comprising:
using the engraving tool to engrave a predetermined design into the back surface of the door.

16. A method according to claim 13 wherein the engraving tool is a computer numeric control router.

17. A method according to claim 13 wherein the core is composed of medium density fiberboard.

18. A method according to claim 17 wherein the medium density fiberboard has a density greater than 40 pounds per cubic foot (640 kg/cubic meter).

19. A method according to claim 17 wherein the medium density fiberboard has an internal bond greater than 80 pounds per square inch (552 kPa).

20. A door according to claim 17 wherein the medium density fiberboard has an internal bond greater than 110 pounds per square inch (759 kPa).
